(19) United States
(12) Patent Application Publication
(10) Pub. No.: US 2023/0033908 A1
(43) Pub. Date: Feb. 2, 2023

(54) GROUND PLANE CANCELLATION FOR COLLISION AVOIDANCE SYSTEM

(71) Applicant: STOCKED ROBOTICS, INC., Austin, TX (US)

(72) Inventor: Rilwan Remilekun Basaru, Pflugerville, TX (US)

(73) Assignee: STOCKED ROBOTICS, INC., Austin, TX (US)

(21) Appl. No.: 17/388,601

(22) Filed: Jul. 29, 2021

(51) Int. Cl. B60W 30/09

(52) U.S. Cl. CPC B60W 30/09; B60W 2520/16; B60W 2520/18; B60W 2420/42; B60W 2554/4049

(57) ABSTRACT

A system for ground plane cancellation, comprising an image data system configured to generate image data and associated coordinate data for pixels contained in the image data. A ground plane calculation system configured to generate ground plane coordinate data. A ground plane correction system configured to subtract pixels associated with the ground plane coordinate data from the image data.

### TECHNICAL FIELD

The present disclosure relates generally to vehicle navigation systems, and more specifically to a system and method for ground plane cancellation for a collision avoidance system.

### BACKGROUND OF THE INVENTION

Vehicle control systems are used to prevent collisions, but must rely on large data sets that can be difficult to process.

### SUMMARY OF THE INVENTION

Systems and methods for ground plane cancellation are disclosed that include an image data system configured to generate image data and associated coordinate data for pixels contained in the image data. A ground plane calculation system is configured to generate ground plane coordinate data. A ground plane correction system is configured to subtract pixels associated with the ground plane coordinate data from the image data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for ground plane cancellation to augment collision avoidance, in accordance with an example embodiment of the present disclosure; and

FIG. 2 is a diagram of an algorithm for ground plane cancellation to augment collision avoidance, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

A collision avoidance and obstacle detection system of the present disclosure can be installed on a vehicle after it has been manufactured, and can use a depth camera that generates data that represents the proximity of all points in its field of view. The depth camera can be installed in a suitable location on the vehicle, and as a result, it can have a height that must be specifically determined as a part of the installation process. In addition, the camera can be placed on a vehicle structural component that is subject to movement in 3 axes, such that the orientation of the camera to ground can be constantly changing. The system of the present disclosure can indicate to the driver of an associated vehicle when one or more points are detected that are within a preset proximity zone, but one consequence of this configuration is that the depth camera can perceive the ground as an obstacle, because the camera is oriented arbitrarily. As a result, a system and method for ground plane filtering is also provided, in order to increase the reliability of the data that is used for collision avoidance. In this regard, the present disclosure increases the reliability of data by eliminating the effects of environmental noise from the image data, to improve the operation of the system

In one example embodiment, data from an inertial measurement device (IMU) of the camera or other suitable IMUs can be used to estimate the pitch and roll angle the camera makes with respect to gravity, because gravity will typically be perpendicular to the ground plane. In another example embodiment, an incline detection device or image data processing technique can be used to determine when the ground plane is at an angle, such as when a vehicle is travelling on an inclined roadway. The detected distance of all points in the 3D point cloud observed by the depth camera can then be adjusted as a function of the previously estimated pitch and roll angle, to provide a virtual re-orientation of the camera so that the image data is perpendicular gravity and consequently parallel to the ground plane or the incline-adjusted ground plane. When that is done, observed data points having a vertical distance within a predetermined tolerance to the distance of the camera from the ground plane can be deleted from the data set that is subsequently processed by a collision avoidance system, which can increase the reliability of the output of the collision avoidance system.

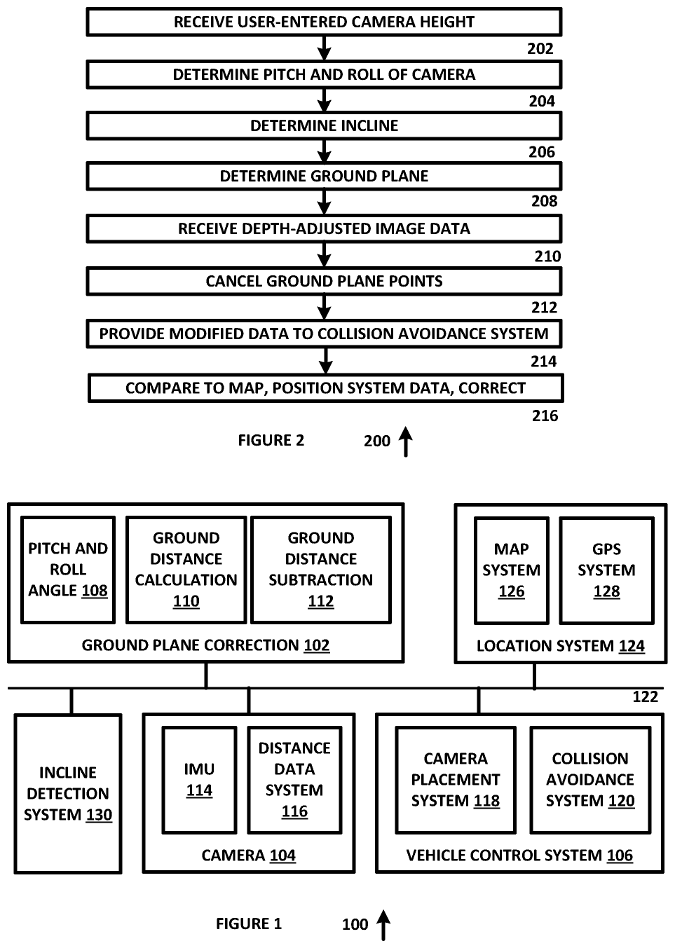

FIG. 1 is a diagram of a system 100 for ground plane cancellation to augment collision avoidance, in accordance with an example embodiment of the present disclosure. System 100 includes ground plane correction system 102, camera 104, vehicle control system 106, pitch and roll angle system 108, ground distance calculation system 110, ground distance subtraction system 112, IMU 114, distance data system 116, camera placement system 118, collision avoidance system 120, network 122, location system 124, map system 126, GPS system 128 and incline detection system 130, each of which can be implemented in hardware or a suitable combination of hardware and software.

Ground plane correction system 102 can be one or more algorithms loaded into a data memory device of a processor to cause the processor to perform the functions of receiving data and identifying ground plane correction data. In one example embodiment, ground plane correction system 102 can determine an angular orientation of a set of image data to a ground plane and a distance to ground and can modify the set of image data to cancel ground plane image data from the set of image data. The resulting modified set of image data can thus be more readily processed by a collision avoidance system to detect potential obstacles and to take evasive action.

Camera 104 can be one or more camera data systems that are configured to generate pixels of image data for a field of view. In one example embodiment, camera 104 can include additional functionality, such as an IMU, distance determination hardware that determines a distance associated with each pixel or other suitable hardware. Camera 104 can receive and process control data from an external controller to modify its operation, can generate sets of image data with associated data such as IMU data and distance data and can perform other suitable functions.

Vehicle control system 106 can be one or more algorithms loaded into a data memory device of a processor to cause the processor to perform the functions of generating vehicle control data. In one example embodiment, vehicle control system 106 can store vehicle configuration data for one or more vehicle systems and components that were installed in the field, can generate control data for controlling the operations of the vehicle and can perform other suitable functions. In this example embodiment, a vehicle can have a vehicle control bus that is installed to provide data communications between vehicle control system 106 and control systems of a vehicle, such as a braking system, an acceleration system, a direction control system, operator notification systems and other suitable systems. Vehicle control system 106 and the associated control systems can be added or modified on an existing vehicle, to allow the vehicle to be retrofitted to allow a vehicle control system with ground plane cancellation to be added to an existing vehicle. In this manner, existing vehicles can be provided with a vehicle control system with ground plane cancellation and it is not necessary to purchase a completely new vehicle to obtain the inventive features discussed and disclosed herein.

Pitch and roll angle system 108 can be one or more algorithms loaded into a data memory device of a processor to cause the processor to perform the functions of estimating orientation with respect to gravity using IMU sensors. In one example embodiment, an IMU sensor can include an accelerometer and a gyroscope. A 3-Axis accelerometer can be used to measure acceleration (in ms−2) experienced by the sensor on all of its axes. An estimation of an orientation of the object with respect to gravity can be calculated as:

θacc=arctan(accy/accx) (equation 1)

where accx and accy are the measured acceleration in the x-axis and y-axis respectively. A gyroscope can be used to measure an angular rate of an object it is attached to, such as the rate of change in the angular orientation (θ/s) of the attached object. Noise in both measurement systems can be compensated for by combining measurements from both to get a more robust estimate of the orientation of the object that they are attached to (such as a camera) with respect to gravity. An angular complementary filter equation can be used to continuously estimate the orientation θt at time t as:

θt=α*(θt−1+ωgyro*dt)+(1−α)*θacc (equation 2)

where α is the arbitrarily selected filter factor, dt is the elapsed time between the time of the current measurement, t and the previous while ωgyro is the measured angular velocity as measured by the gyroscope and θacc is the calculated angular orientation calculated using equation 1. This process can be used for a single plane and applied to each plane of a three-dimensional system.

The elevation of an observed real point PR can be determined from the elevation of the camera and the vertical distance of the point to the camera's principal axis. The former can be set by the user of the system based on how far of the ground the camera is physically install/mounted. The latter can inferred from the location at which the point is observed in the 2D image captured by the camera. The task of resolving the vertical distance of the real point PR to the camera's principal axis, can be framed as determining the 3D location of the point P relative to the camera's frame of reference. To do this, a virtual line can be projected from the point P_{V} (the 2D location on the virtual/captured image where the point PR is observed) through the optical center of the camera and into 3D scene being observed. The ‘straight path of travel’ property of light constrains PR to exist on this projected line, which provides the direction of the vector representation of PR in the camera frame of reference. The 3D coordinate of the point PR in the camera frame of axis can then be fully resolved with the scalar distance of the point to the camera, such as by using depth information provided by the camera or other suitable data.

Ground distance calculation system 110 can be one or more algorithms loaded into a data memory device of a processor to cause the processor to perform the functions of determining the distance of an observed point to ground relative to a camera. In one example embodiment, the distance to ground can vary as a function of the distance from the camera to a point on the ground, which can be determined based on a known height of the camera above the ground and a known orientation of the ground plane to the camera, such as using pitch and roll data from pitch and roll angle system 108, incline data from incline detection system 130 and other suitable data. In this manner, the calculated distance of the observed point to ground as a function of distance measured from the camera can be determined. Likewise, other suitable processes can also or alternatively be used.

Ground distance subtraction system 112 can be one or more algorithms loaded into a data memory device of a processor to cause the processor to perform the functions of subtracting the calculated distance to ground at each point in an array of pixel data from measured distance data at that point, and by further eliminating the pixel data at that point if the difference between the calculated distance to ground and the measured distance to ground is within a predetermined tolerance.

IMU 114 can be one or more hardware devices that generate inertial measurement data that can be used to derive a change in orientation and position of an object that IMU 114 is associated with or attached to. In one example embodiment, IMU 114 can generate inertial measurement data along three axes, and can monitor changes in the inertial measurements to derive angular acceleration data, angular position data or other suitable data. The data can be generated in a predetermined format to allow it to be used by external data processing systems.

Distance data system 116 can be one or more algorithms loaded into a data memory device of a processor to cause the processor to perform the functions of generating distance data using one or more hardware devices. In one example embodiment, the hardware devices can use laser, stereo image data or other suitable data to determine an estimate distance to each point of a plurality of points in a two dimensional array of image data. The distance data can be associated with each pixel, with groups of pixels or in other suitable manners, and can be used to determine a distance between a camera and points in the field of view of the camera, or other for other suitable purposes.

Camera placement system 118 can be one or more algorithms loaded into a data memory device of a processor to cause the processor to perform the functions of identifying a placement location of a camera. In one example embodiment, camera placement system 118 can store data that identifies a location of a camera in three dimensions, can determine a placement of a camera that can be robotically deployed or can otherwise generate camera placement data.

Collision avoidance system 120 can be one or more algorithms loaded into a data memory device of a processor to cause the processor to perform the functions of determining whether an object exists in a path of a vehicle and generating suitable control data in response, such as braking data, deceleration data or other suitable data. In one example embodiment, collision avoidance system can process image data, map data, GPS data, distance data or other suitable data to determine a vehicle location, a location of an object and other suitable data that can be used to avoid a collision with an object in the path of travel of a vehicle.

Network 122 can be implemented in hardware or a suitable combination of hardware and software, and can control the transmission of data between hardware and software systems that are configured to communicate using network 122. Network 122 can provide data security and other suitable associated functionality, to prevent malicious actors from engaging in unauthorized activity.

Location system 124 can be one or more algorithms loaded into a data memory device of a processor to cause the processor to perform the functions of generating location data for a vehicle, for detected objects and other suitable functions. In one example embodiment, location system 124 can cross-reference location data using multiple sources of data, can generate location reliability data and can perform other suitable functions.

Map system 126 can be one or more algorithms loaded into a data memory device of a processor to cause the processor to perform the functions of generating map data associated with a vehicle, an obstacle or other suitable objects. In one example embodiment, a location of a vehicle on a two or three dimensional map can be tracked, to allow the proximity of the vehicle to known obstacles to be determined. In another example embodiment, the location of a detected obstacle can be stored, stored obstacle data can be used to verify whether a detected obstacle has been previously observed and other suitable functions can also or alternatively be provided.

GPS system 128 can be one or more algorithms loaded into a data memory device of a processor to cause the processor to perform the functions of receiving Global Positioning Satellite (GPS) data and generating position data in response. In one example embodiment, the GPS data can include timing information from one or more sources that can be used to generate positional data at the receiver in a global coordinate system, or other suitable data.

Incline detection system 130 can be one or more algorithms loaded into a data memory device of a processor to cause the processor to perform the functions of receiving incline data from a device and generating incline data. In one example embodiment, incline detection system can use a mechanical incline detection device, image data or other suitable data to determine whether a vehicle is travelling on an inclined roadway, such as a roadway that is going up or down a hill.

FIG. 2 is a diagram of an algorithm 200 for ground plane cancellation to augment collision avoidance, in accordance with an example embodiment of the present disclosure. Algorithm 200 can be implemented in hardware or a suitable combination of hardware and software.

Algorithm 200 begins at 202, where a user-entered camera height is received. In one example embodiment, a camera can be installed as part of a vehicle automation system installation on an existing vehicle, and the camera placement can be a function of a number of variables, including vehicle frame modifications and camera design, which can require the height of the camera as mounted to be measured and provided to the system. The algorithm then proceeds to 204.

At 204, the pitch and roll of a camera is determined. In one example embodiment, an IMU of the camera or one that is associated with the camera can be used to generate accelerometer data that can be processed to generate real time pitch and roll data for the camera, to allow a normal direction to ground to be determined. The algorithm then proceeds to 206.

At 206, the incline of the camera is determined. In one example embodiment, the incline can be a dynamic incline that is continuously monitored and used to process image data, such as to accommodate changes in the camera inclination angle due to driving over bumps, up a hill or ramp or other causes. The incline can be determined using an electromechanical transducer, IMU data, image data or in other suitable manners. The algorithm then proceeds to 208.

At 208, the ground plane is determined. In one example embodiment, the height of the camera to ground is used to determine coordinates of a ground plane that extends along the angle relative to any incline. The algorithm then proceeds to 210.

At 210, depth-adjusted image data is received. In one example embodiment, the depth-adjusted image data can be generated by LIDAR, stereoscopic camera systems or in other suitable manners, and can include depth data associated with pixels, groups of pixels or in other suitable manners. The algorithm then proceeds to 212.

At 212, ground plane points are cancelled. In one example embodiment, the calculated ground plane location data can be used to process the depth-adjusted image data to identify pixels associated with the ground plane, to allow that pixel data to be deleted to facilitate processing of the remaining data. The algorithm then proceeds to 214.

At 214, the modified data is provided to a collision avoidance system. In one example embodiment, the collision avoidance system can identify obstacles and can determine an appropriate response to an obstacle, such as to slow down and stop before running into the obstacle, to drive around the obstacle or to take other suitable actions. The collision avoidance system can generate vehicle control data in response to the modified data. The algorithm then proceeds to 216.

At 216, a location of an obstacle is compared to map or position system data and corrections are made if needed. In one example embodiment, obstacles can be identified as temporary or permanent, and can be used for route planning or other suitable purposes. The algorithm then terminates

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for ground plane cancellation, comprising:
an image data system operating on a processor having a memory device and configured to generate image data and associated coordinate data for pixels contained in the image data and to store the image data and the associated coordinate data for pixels contained in the image data in the memory device;
a ground plane correction system operating on the processor and configured to receive the image data and associated coordinate data for pixels contained in the image data from the memory device, to subtract pixels associated with a ground plane from the image data to generate ground-plane cancelled image data, and to store the ground-plane cancelled image data in the memory device; and
a vehicle control system operating on the processor and configured to receive the ground-plane cancelled image data from the memory device and to generate vehicle control data using the ground-plane cancelled image data that is transmitted over a vehicle data bus to control one or more systems of a vehicle to cause a change in vehicle operations.

2. The system of claim 1 wherein the ground plane correction system further comprises a pitch and roll angle system configured to receive sensor data and to generate pitch and roll angle data.

3. The system of claim 2 wherein the ground plane correction system further comprises a ground distance calculation system configured to receive the pitch and roll angle data and to generate ground distance data.

4. The system of claim 3 wherein the ground plane correction system further comprises a ground distance calculation system configured to receive the pitch and roll angle data and camera height data and to generate ground distance data using the pitch and roll angle data and camera height data.

5. The system of claim 1 further comprising an incline detection system configured to receive sensor data from an incline measurement device and to generate angle of incline data.

6. The system of claim 5 wherein the ground plane correction system further comprises a ground distance calculation system configured to receive the angle of incline data and to generate ground distance data.

7. The system of claim 1 wherein the ground plane correction system further comprises a pitch and roll angle system configured to receive inertial measurement unit data and to generate pitch and roll angle data.

8. The system of claim 1 further comprising a map system configured to generate map data, and wherein the vehicle control system is configured to receive the map data and to update the map data to include obstacle data as a function of the ground-plane cancelled image data.

9. The system of claim 1 further comprising a distance data system configured to generate distance data for each of the pixels of the image data.

10. A method for ground plane cancellation, comprising:
generating image data and associated coordinate data for pixels contained in the image data;
storing the image data and the associated coordinate data for pixels contained in the image data in a memory device;
receiving the image data and associated coordinate data for pixels contained in the image data from the memory device and subtracting pixels associated with a ground plane from the image data to generate ground-plane cancelled image data;
storing the ground-plane cancelled image data in the memory device;
generating vehicle control data using the ground-plane cancelled image data; and
transmitting the vehicle control data over a vehicle data bus to control one or more systems of a vehicle to cause a change in vehicle operations.

11. The method of claim 10 further comprising receiving sensor data and generating pitch and roll angle data.

12. The method of claim 11 further comprising receiving the pitch and roll angle data and generating ground distance data.

13. The method of claim 12 further comprising receiving the pitch and roll angle data and camera height data and generating ground distance data using the pitch and roll angle data and camera height data.

14. The method of claim 10 further comprising receiving sensor data from an incline measurement device and generating angle of incline data.

15. The method of claim 14 further comprising receiving the angle of incline data and to generating ground distance data.

16. The method of claim 10 further comprising receiving inertial measurement unit data and generating pitch and roll angle data.

17. The method of claim 10 further comprising generating map data, receiving the map data at a vehicle control system and updating the map data to include obstacle data as a function of the ground-plane cancelled image data.

18. The method of claim 10 further comprising a distance generating distance data for each of the pixels of the image data.
